(19) United States
(12) Patent Application Publication
(10) Pub. No.: US 2016/0231638 A1
(43) Pub. Date: Aug. 11, 2016

(54) OPTICAL MODULATION DEVICE, DRIVING METHOD THEREOF, AND OPTICAL DEVICE USING THE SAME

(71) Applicant: SAMSUNG DISPLAY CO., LTD., Yongin-Si (KR)

(72) Inventors: Jeong Min SUNG, Seoul (KR); Kang-Min KIM, Hwaseong-Si (KR); Tae Hyung KIM, Anyang-Si (KR); Hyung Woo YIM, Goyang-Si (KR)

(21) Appl. No.: 14/849,072

(22) Filed: Sep. 9, 2015

(30) Foreign Application Priority Data
Feb. 5, 2015 (KR) 10-2015-0018149

(51) Int. Cl. G02F 1/29; G02F 1/1343

(52) U.S. Cl. CPC G02F 1/29; G02F 1/134309

(57) ABSTRACT

An optical modulation device includes following elements. Bus lines are extended in a first direction, wherein each bus line supplies a respective voltage. A first plate includes first lower electrodes extended in a second direction crossing the first direction, wherein a rightmost first lower electrode is connected to a first bus line of the bus lines and a leftmost first lower electrode is connected to a second bus line of the bus lines. A second plate faces the first plate, and includes at least one upper electrode. A liquid crystal layer is positioned between the first plate and the second plate and includes liquid crystal molecules. A first resistor string includes first resistors, wherein each resistor positioned between two adjacent first lower electrodes connects electrically the two adjacent first lower electrodes, causing a voltage drop between the two adjacent first electrodes.

### CROSS-REFERENCE TO RELATED APPLICATION

This application claims priority under 35 U.S.C. §119 to Korean Patent Application No. 10-2015-0018149 filed on Feb. 5, 2015 in the Korean Intellectual Property Office, the disclosure of which i8s incorporated herein by reference.

### TECHNICAL FIELD

The present invention relates to an optical modulation device including a liquid crystal, a driving method thereof, and an optical device using the same.

### DISCUSSION OF THE RELATED ART

Recently, an optical device using an optical modulation device which modulates optical characteristics has been actively developed. For example, an optical display device which may display a three dimensional (3D) image has drawn much attention and an optical modulation device for separating an image at different timings and transmitting the separated images to enable a viewer to recognize an image as a three-dimensional image is needed. As the optical modulation device which may be used in an autostereoscopic image display device, there are a lens, a prism, and the like which changes a path of light of an image of a display device and transmits the light at a desired viewpoint.

As such, to change a direction of incident light, a diffraction of light by phase modulation of light may be used.

When polarized light transmits the optical modulation device such as a phase delayer, a polarization state is changed. For example, when circularly polarized light is incident on a half-wavelength plate, a rotating direction of the circularly polarized light is changed reversely and thus light is emitted. For example, when light which is circularly polarized to the right transmits the half-wavelength plate, light which is circularly polarized to the left is emitted. In this case, a phase of the circularly polarized light which is emitted depending on an angle of an optical axis of the half-wavelength plate, that is, a slow axis is changed. In detail, when the optical axis of the half-wavelength plate rotates as much as φ on an in-plane, the phase of the output light is changed as much as 2φ. Therefore, when the optical axis of the half-wavelength plate rotates as much as 180° (it radian) in an x-axis direction on a space, the emitted light is subjected to a phase modulation or a phase change of 360° (2π radian) in the x-axis direction and may then be emitted. As such, when the optical modulation device changes the phase of light from 0 to 2π depending on a position, a diffraction lattice or a prism which may change or bend the direction of transmitted light ma be implemented.

To control the optical axis depending on the position of the optical modulation device such as the half-wavelength plate, a liquid crystal may be used. The optical modulation device implemented as the phase delayer using the liquid crystal may rotate major axes of aligned liquid crystal molecules by applying an electric field to a liquid crystal layer to generate other phase modulations depending on the position. The phase of light which is emitted by transmitting the optical modulation device may be determined depending on a direction of the major axis of the aligned liquid crystal, that is, an azimuthal angle.

### SUMMARY

According to an exemplary embodiment of the present invention, an optical modulation device includes following elements. Bus lines are extended in a first direction, wherein each bus line supplies a respective voltage. A first plate includes first lower electrodes extended in a second direction crossing the first direction, wherein a rightmost first lower electrode is connected to a first bus line of the bus lines and a leftmost first lower electrode is connected to a second bus line of the bus lines. A second plate faces the first plate, and includes at least one upper electrode. A liquid crystal layer is positioned between the first plate and the second plate and includes liquid crystal molecules. A first resistor string includes first resistors, wherein each resistor positioned between two adjacent first lower electrodes connects electrically the two adjacent first lower electrodes, causing a voltage drop between the two adjacent first electrodes.

According to an exemplary embodiment of the present invention, an optical device includes the following elements. An optical modulation device includes spiral zones, wherein each spiral zone includes a plurality of lower electrodes. Bus lines are connected to the lower electrodes in a predetermined manner. A voltage control device generates voltages applied to the optical modulation device through the bus lines. A number of lower electrodes of each zone is different from a number of lower electrodes of a neighboring spiral zone.

According to an exemplary embodiment of the present invention, a driving method of an optical modulation device includes the following steps. A first voltage is received through a first bus line connected to a leftmost first lower electrode of first lower electrodes. A second voltage is received through a second bus line connected to a rightmost first lower electrode of the first lower electrodes. A voltage difference between the first voltage and the second voltage is divided through first resistors positioned between the first lower electrodes. The divided voltage is applied to the first lower electrodes.

### BRIEF DESCRIPTION OF THE DRAWINGS

These and other features of the present invention will become more apparent by describing in detail exemplary embodiments thereof with reference to the accompanying drawings of which:

FIG. 1 is a perspective view of an optical modulation device according to an exemplary embodiment of the present invention;

FIG. 2 is a plan view illustrating an alignment direction in a first plate and a second plate included in the optical modulation device of FIG. 1 according to an exemplary embodiment of the present invention;

FIG. 3 is a diagram illustrating a process of bonding the first plate and the second plate of FIG. 2 according to an exemplary embodiment of the present invention;

FIG. 4 is a perspective view illustrating an alignment of liquid crystal molecules when a voltage difference is not applied to the first plate and the second plate of the optical modulation device of FIG. 1 according to an exemplary embodiment of the present invention;

FIGS. 5A to 5C are cross-sectional views of the optical modulation device of FIG. 4 taken along lines I, II, and III according to an exemplary embodiment of the present invention;

FIG. 6 is a perspective view illustrating the alignment of the liquid crystal molecules when the voltage difference is applied to the first plate and the second plate of the optical modulation device of FIG. 1 according to an exemplary embodiment of the present invention;

FIG. 7 is a cross-sectional view of the optical modulation device of FIG. 6 taken along lines I, II, and III according to an exemplary embodiment of the present invention;

FIG. 8 is a perspective view of the optical modulation device according to the exemplary embodiment;

FIG. 9 is a timing diagram of a driving signal of an optical modulation device according to an exemplary embodiment of the present invention;

FIGS. 10A and 10B are cross-sectional views taken along line IV of FIG. 8 illustrating the alignment of liquid crystal molecules before a voltage difference is applied to the first plate and the second plate of the optical modulation device according to the exemplary embodiment and after a driving signal of step 1 is applied;

FIG. 11 is a cross-sectional view taken along the line V of FIG. 8 illustrating a stabilized alignment of the liquid crystal molecules after the driving signal of the step 1 is applied to the optical modulation device according to an exemplary embodiment and is a graph illustrating a phase change of light passing through the liquid crystal molecules;

FIG. 12 is a diagram illustrating a stabilized alignment of the liquid crystal molecules after the driving signal of the step 1 is applied to an optical modulation device according to an exemplary embodiment;

FIG. 13 is a cross-sectional view taken along the line IV of FIG. 8 and a cross-sectional views taken along the line V as a cross-sectional view illustrating the alignment of the liquid crystal molecules before the voltage difference is applied to the first plate and the second plate of the optical modulation device according to an exemplary embodiment;

FIG. 14 is a cross-sectional view taken along the line IV of FIG. 8 as a cross-sectional view illustrating the alignment of the liquid crystal molecules when the driving signal of the step 1 is applied to the optical modulation device according to an exemplary embodiment;

FIG. 15 is a cross-sectional view taken along the line IV of FIG. 8 as a cross-sectional view illustrating the alignment of the liquid crystal molecules before being stabilized, after the driving signal of the step 1 is applied to the optical modulation device according to an exemplary embodiment;

FIG. 16 is a cross-sectional view taken along the line IV of FIG. 8 and is a cross-sectional view taken along the line V as a cross-sectional view illustrating the alignment of the stabilized liquid crystal molecules after the driving signal of the step 1 is applied to the optical modulation device according to an exemplary embodiment;

FIG. 17 is a cross-sectional view taken along the line IV of FIG. 8 as a cross-sectional view illustrating the alignment of the liquid crystal molecules before the voltage difference is applied to the first plate and the second plate of the optical modulation device according to an exemplary embodiment and after the driving signals of first to third steps, respectively, are applied;

FIGS. 18 and 19 are cross-sectional views taken along the line of FIG. 8 as a cross-sectional view illustrating the alignment of the liquid crystal molecules in which the alignment is stabilized, after the driving signals of the first to third steps are sequentially applied to the optical modulation device according to an exemplary embodiment;

FIG. 20 is a diagram illustrating a phase change depending on a position of a lens which may be implemented using the optical modulation device according to an exemplary embodiment;

FIGS. 21 and 22 each are diagrams illustrating a structure schematically illustrating a stereoscopic optical device as an example of an optical device using the optical modulation device according to an exemplary embodiment and a method for displaying a 2D image and a 3D image;

FIG. 23 is a diagram illustrating a case in which a resistor string for voltage division is formed in the optical modulation device according to an exemplary embodiment;

FIG. 24 is a diagram illustrating a case of performing RC modeling on a spiral zone of FIG. 23;

FIG. 25 is a spice simulation graph illustrating a voltage applied to an electrode of FIG. 24; and

FIG. 26 is a diagram illustrating a case in which a resistor string is formed in a voltage control device controlling a voltage applied to the optical modulation device according to an exemplary embodiment.

### DETAILED DESCRIPTION OF EXEMPLARY EMBODIMENTS

Exemplary embodiments of the present invention will be described below in detail with reference to the accompanying drawings. However, the present invention may be embodied in different forms and should not be construed as limited to the embodiments set forth herein. In the drawings, the thickness of layers and regions may be exaggerated for clarity. It will also be understood that when an element is referred to as being “on” another element or substrate, it may be directly on the other element or substrate, or intervening layers may also be present. It will also be understood that when an element is referred to as being “coupled to” or “connected to” another element, it may be directly coupled to or connected to the other element, or intervening elements may also be present. Like reference numerals may refer to the like elements throughout the specification and drawings.

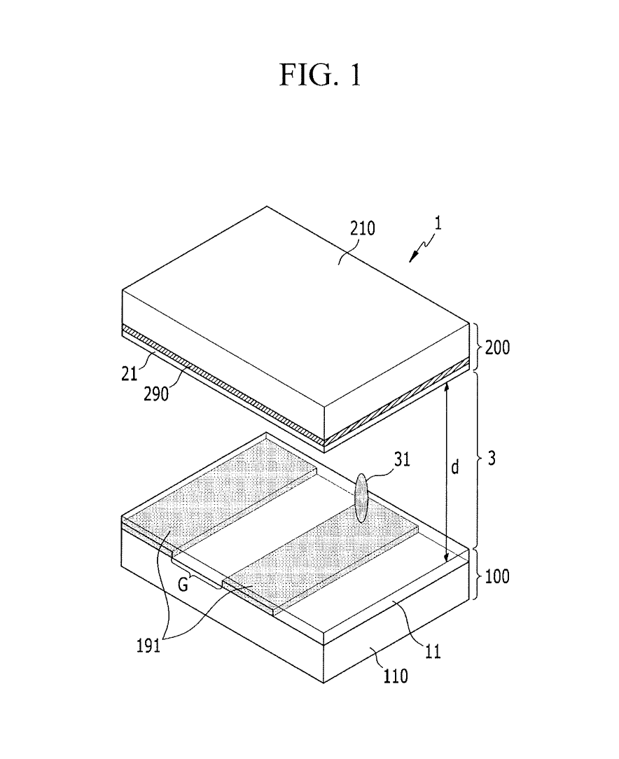

An optical modulation device according to an exemplary embodiment will be described with reference to FIGS. 1 to 3.

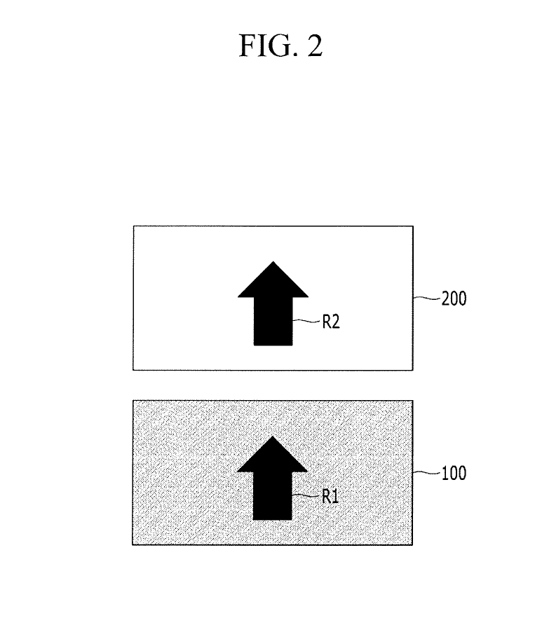

FIG. 1 is a perspective view of an optical modulation device according to an exemplary embodiment, FIG. 2 is a plan view illustrating an alignment direction in a first plate and a second plate included in the optical modulation device of FIG. 1, and

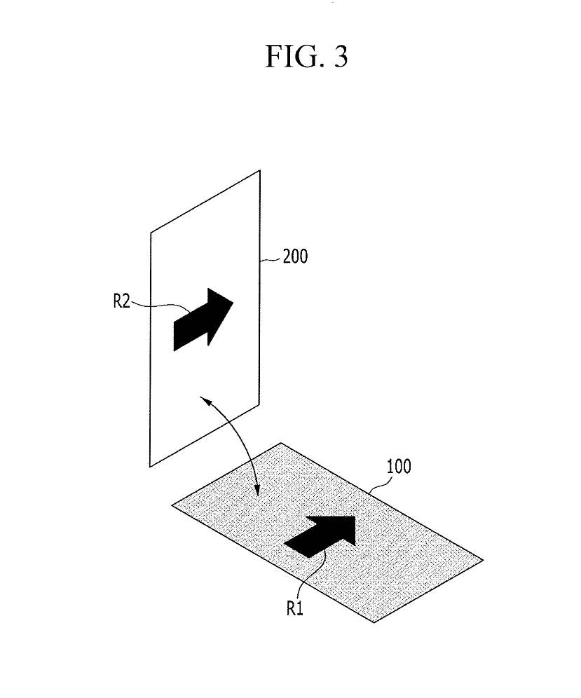

FIG. 3 is a diagram illustrating a process of bonding the first plate and the second plate of FIG. 2.

Referring to FIG. 1, an optical modulation device 1 according to an exemplary embodiment includes a first plate 100 and a second plate 200 which face each other and a liquid crystal layer 3 positioned therebetween.

The first plate 100 may include a first substrate 110 and a plurality of lower electrodes 191. The first substrate 110 may be made of glass, plastic, etc. The first substrate 110 may be rigid or flexible and may be flat or at least partially bent.

The lower electrodes 191 are positioned on the first substrate 110. The lower electrodes 191 may include a conductive material or transparent conductive materials. For example, the lower electrodes 191 may include indium tin oxide (ITO), indium zinc oxide (IZO), metal, or the like. The lower electrodes 191 may be applied with a voltage from a voltage applying configuration (not illustrated). For example, each lower electrode may be applied with different voltages.

The plurality of lower electrodes 191 may be arranged in a predetermined direction, for example, an x-axis direction and each lower electrode 191 may extend long in a vertical direction to the arrangement direction, for example, a y-axis direction.

A width of a space G between the adjacent lower electrodes 191 may be variously controlled depending on a design condition of the optical modulation device. A ratio of the width of the lower electrode 191 and the width of the space G adjacent thereto may be approximately N:1 (N is a real number which is equal to or more than 1).

The second plate 200 may include a second substrate 210 and an upper electrode. The second substrate 210 may be made of glass, plastic, etc. The second substrate 210 may be rigid or flexible and may be flat or at least partially bent.

The upper electrode 290 is formed on the second substrate 210. The upper electrode 290 may include a conductive material or transparent conductive materials. For example, the upper electrode 290 may include ITO, IZO, metal, or the like. The upper electrode 290 may be applied with a voltage from a voltage applying configuration (not illustrated). The upper electrode 290 may be applied with a ground voltage. In an exemplary embodiment, various voltages other than the ground voltage may apply to the upper electrode 290. The upper electrode 290 may be formed on the second substrate 210 as a whole body. In an exemplary embodiment, the upper electrode 290 may be patterned to include a plurality of spaced portions.

The liquid crystal layer 3 includes a plurality of liquid crystal molecules 31. The liquid crystal molecules 31 may have a negative dielectric anisotropy to be aligned in a transverse direction to an electric field generated in the liquid crystal layer 3. The liquid crystal molecules 31 may be aligned in approximately a vertical direction to the second plate 200 and the first plate 100 in the state in which an electric field is not generated in the liquid crystal layer 3. In an exemplary embodiment, the liquid crystal molecules 31 may pre-tilted in a specific direction. The liquid crystal molecule 31 may be a nematic liquid crystal molecule.

A height d of a cell gap of the liquid crystal layer 3 may substantially satisfy the Equation 1 for light having a specific wavelength 2. As a result, the optical modulation device 1 according to an exemplary embodiment may serve as approximately a half-wavelength plate and may be used as a diffraction lattice, a lens, or the like.

$$\frac{λ}{2} \times 1.3 \geq Δ nd \geq \frac{λ}{2} \qquad ( Equation 1 )$$

In the above Equation 1, Δnd is a phase delay value of light transmitting the liquid crystal layer 3.

An inner surface of the first plate 100 is provided with a first aligner 11 and an inner surface of the second plate 200 is provided with a second aligner 21. The first aligner 11 and the second aligner 21 may be a vertical alignment layer and may have an alignment force by various methods such as a rubbing process and a photo alignment process to determine a pre-tilt direction of the liquid crystal molecules 31 which are close to the first plate 100 and the second plate 200. In the case of the rubbing process, the vertical alignment layer may be an organic vertical alignment layer. In the case of using the photo alignment process, an alignment material including a photosensitive polymer material is applied to the inner surfaces of the first plate 100 and the second plate 200 and then light such as ultraviolet rays is irradiated thereto to form a photopolymerization material.

Referring to FIG. 2, alignment directions R1 and R2 of two aligners 11 and 21 which are positioned on the inner surfaces of the first plate 100 and the second plate 200 are substantially parallel with each other. Further, the alignment directions R1 and R2 are constant.

When considering a misalign margin between the first plate 100 and the second plate 200, a difference between an azimuthal angle of the first aligner 11 of the first plate 100 and an azimuthal angle of the second aligner 21 of the second plate 200 may be approximately ±5°, but the present invention is not limited thereto.

Referring to FIG. 3, the first plate 100 and the second plate 200 in which the aligners 11 and 21 are substantially aligned in parallel with each other may be aligned and bonded to each other to form the optical modulation device 1 according to an exemplary embodiment.

Differently from the illustrated case, the upper and lower position of the first plate 100 and the second plate 200 may be changed

As described above, according to the exemplary embodiment, the aligners 11 and 21 which are formed in the first plate 100 and the second plate 200 of the optical modulation device 1 including the liquid crystal are parallel with each other and the alignment directions of each aligner 11 and 21 are constant, and as a result, the alignment process of the optical modulation device is simple and the complicated alignment process is not required, thereby simplifying the manufacturing process of the optical modulation device 1. Therefore, the badness of the optical modulation device or the optical device including the same due to the alignment badness may be prevented. Therefore, a size of the optical modulation device may be easily large.

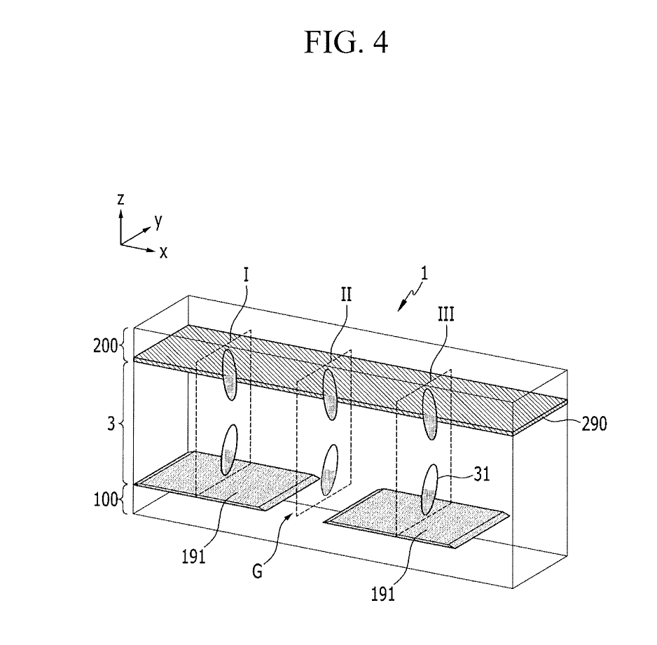

Next, an operation of the optical modulation device according to an exemplary embodiment will be described with reference to FIGS. 4 to 7 along with FIGS. 1 to 3 which are described above.

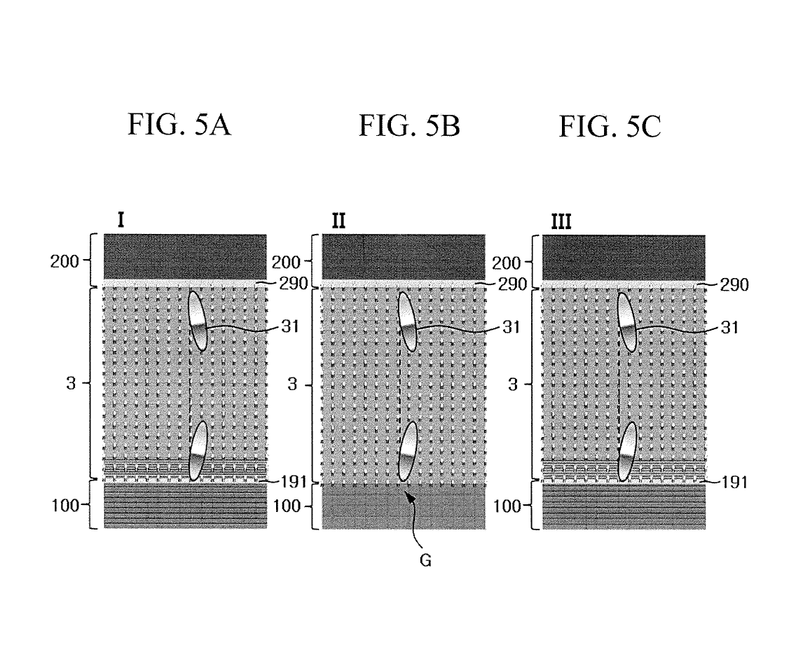

Referring to FIGS. 4 and 5, when a voltage difference is not applied between the lower electrode 191 of the first plate 100 and the upper electrode 290 of the second plate 200 and thus no electric field is not applied to the liquid crystal layer 3, the liquid crystal molecules 31 are aligned, having an initial pre-tilt. FIGS. 5A to 5C are cross-sectional views of the optical modulation device 1 of FIG. 4 taken along lines I, II and III, respectively. The cross-sectional view of FIG. 5A is taken crossing a first lower electrodes 191. The cross-sectional view of FIG. 5C is taken crossing a second lower electrode 191. The cross-sectional view of FIG. 5B is taken crossing the space G interposed between the first and second lower electrodes 191. In this case, the alignment of the liquid crystal molecules 31 may be approximately constant. [Note to client: uniform].

The drawings of FIG. 5, or the like illustrate that some of the liquid crystal molecules 31 are penetrated into an area of the first plate 100 or the second plate 200, which is illustrated for convenience. Actually, the liquid crystal molecules 31 are not penetrated into the area of the first plate 100 or the second plate 200, which is the same even in the following drawings.

The liquid crystal molecules 31 adjacent to the first plate 100 and the second plate 200 are initially aligned along the parallel alignment direction of the aligners 11 and 21. The pre-tilt direction of the liquid crystal molecules 31 adjacent to the first plate 100 and the pre-tilt direction of the liquid crystal molecules 31 adjacent to the second plate 200 are opposite to each other while not being in parallel. For example, the liquid crystal molecules 31 adjacent to the first plate 100 and the liquid crystal molecule 31 adjacent to the second plate 200 may be tilted in a symmetrical direction to each other with respect to a horizontal central line which horizontally extends along a center of the liquid crystal layer 3 on the cross-sectional view. For example, when the liquid crystal molecules 31 adjacent to the first plate 100 are tilted to the right, the liquid crystal molecules 31 adjacent to the second plate 200 may be tilted to the left.

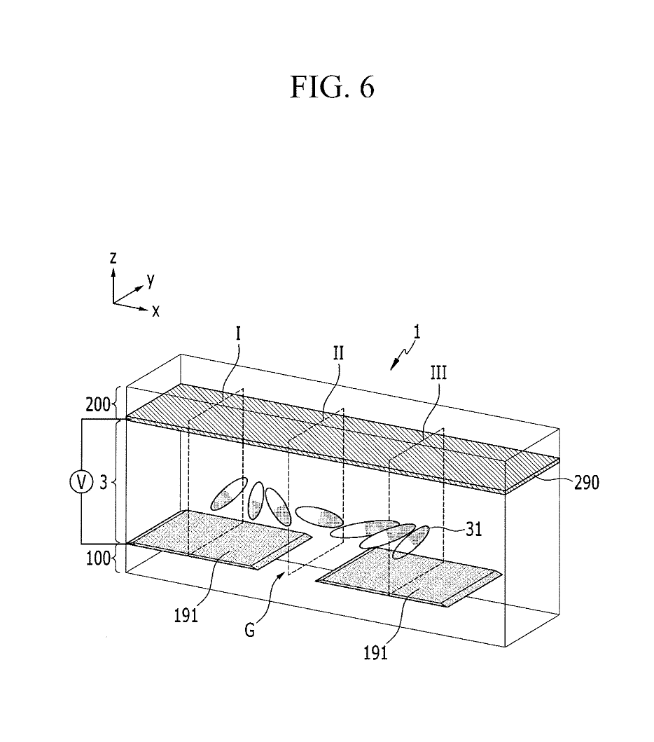

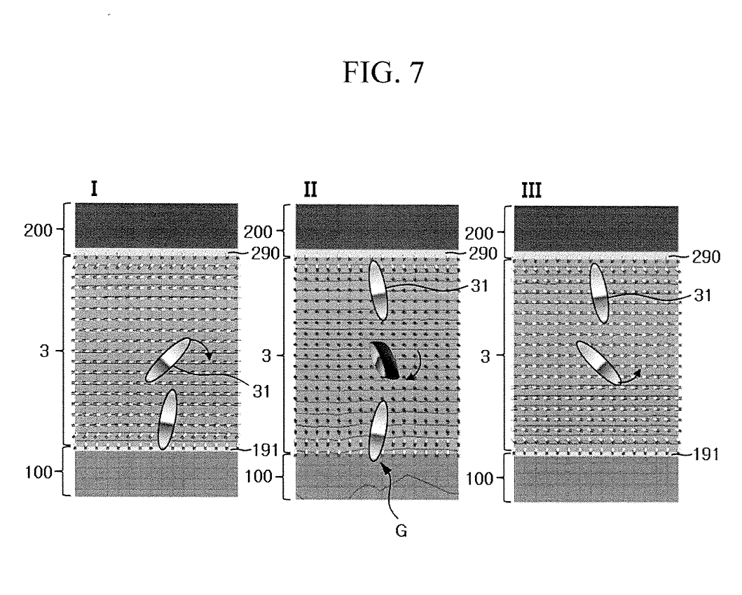

Referring to FIGS. 6 and 7, a voltage difference which is equal to or more than a threshold voltage is applied between the lower electrode 191 of the first plate 100 and the upper electrode 290 of the second plate 200, and thus the liquid crystal molecules 31 having a negative dielectric anisotropy immediately after an electric field is generated in the liquid crystal layer 3 may be tilted in a vertical direction to the direction of the electric field. Therefore, as illustrated in FIGS. 6 and 7, the liquid crystal molecules 31 are tilted in approximately parallel with the surface of the first plate 100 or the second plate 200 to form an in-plane alignment and a major axis of the liquid crystal molecule 31 are arranged with rotating on an in-plane. The in-plane alignment means that the major axis of the liquid crystal molecule 31 is arranged to be parallel with the surface of the first plate 100 or the second plate 200.

In this case, a voltage is applied to the lower electrode 191 and the upper electrode such that the rotating angle (azimuthal angle) of the liquid crystal molecule 31 on the in-plane may be changed in a spiral shape depending on the position of the x-axis direction.

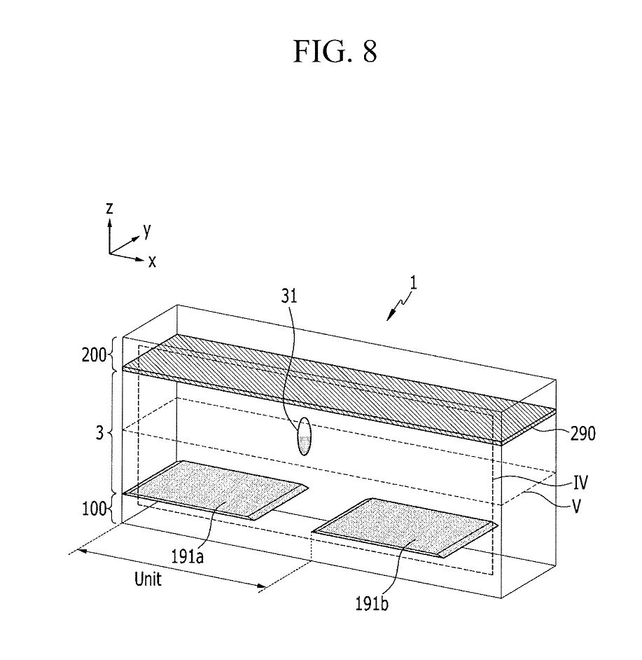

Next, a method for implementing a forward phase tilt using an optical modulation device according to an exemplary embodiment will be described with reference to FIGS. 8 to 12 along with the drawings described above.

FIG. 8 illustrates the optical modulation device 1 including the liquid crystal according to the exemplary embodiment which may have the same structure as the foregoing exemplary embodiment. The optical modulation device 1 may include a plurality of unit region, in which each unit region may include at least one lower electrode 191. The exemplary embodiment describes an example in which each unit region includes one lower electrode 191. The two lower electrodes 191a and 191b which are each positioned in two adjacent unit regions will be described herein. The two lower electrodes 191a and 191b are each called a first electrode 191a and a second electrode 191b.

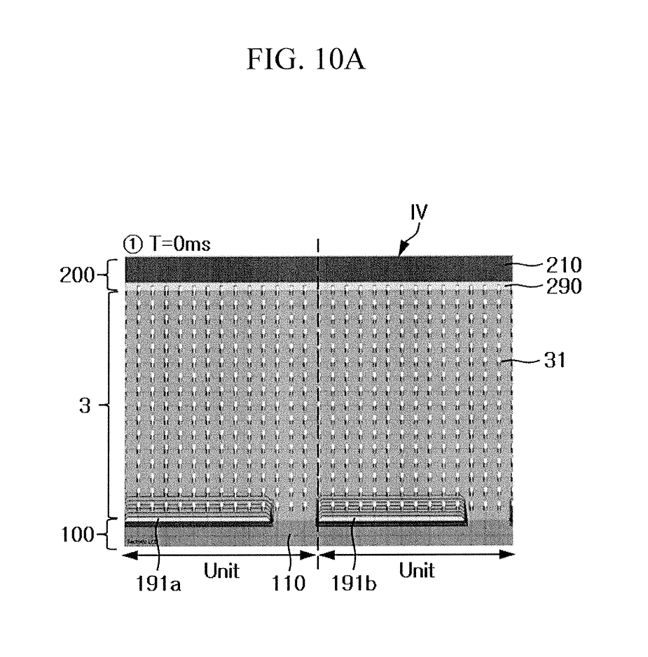

Referring to FIG. 10A, when a voltage is not applied to the first and second electrodes 191 and 191b and the upper electrode 290, the liquid crystal molecules 31 are initially aligned in a substantially vertical direction to a plane of the first plate 100 and the second plate 200 and as described above, may have the pre-tilt along the alignment direction of the first plate 100 and the second plate 200. In this case, a voltage of 0V with reference to the voltage of the upper electrode 290 may be applied to the first and second electrodes 191a and 191b and a voltage which is equal to or less than a threshold voltage Vth at which the alignment of the liquid crystal molecules 31 starts to change may also be applied thereto.

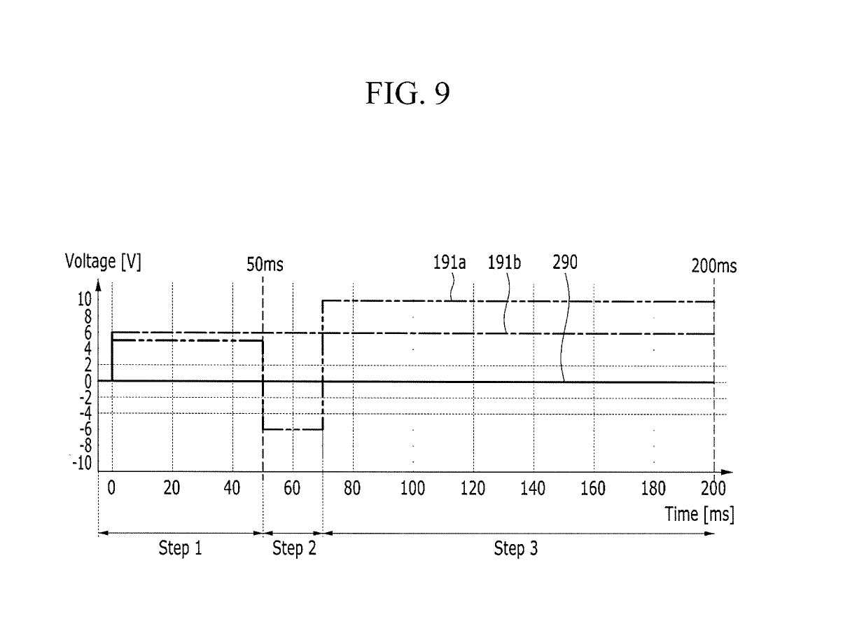

Referring to FIG. 9, first, for a forward phase tilt of liquid crystal molecules, the adjacent lower electrodes 191a and 191b and the upper electrode 290 may be applied with a driving signal of step 1 for one frame. In the step 1, a voltage difference is also formed between the first electrode 191a and second electrode 191b which are adjacent to each other while the voltage difference is formed between the lower electrodes 191a and 191b of the first plate 100 and the upper electrode 290 of the second plate 200. For example, a size of an absolute value of a second voltage applied to the second electrode 191b may be larger than that of a first voltage applied to the first electrode 191a. Further, a third voltage applied to the upper electrode 290 is different from the first voltage and the second voltage applied to the lower electrodes 191a and 191b. For example, the third voltage applied to the upper electrode 290 may be smaller than the absolute value of the first voltage and the absolute value of the second voltage which are applied to the first and second electrodes 191a and 191b. For example, 5V may be applied to the first electrode 191a, 6V may be applied to the second electrode 191b, and 0V may be applied to the upper electrode 290.

Unlike the illustrated case, when the unit region includes a plurality of lower electrodes 191, the same voltage may also be applied to all the plurality of lower electrodes 191 of a single unit region. In an exemplary embodiment, a voltage which is sequentially changed based on at least one lower electrode 191 as a unit may be applied. In this case, a voltage gradually increasing based on at least one lower electrode 191 as a unit may be applied to the lower electrode 191 in one unit region based on a boundary of the adjacent unit regions oe a voltage gradually decreasing based on at least one lower electrode 191 as a unit may be applied to the lower electrode 191 of the other unit region.

The voltage applied to the lower electrodes 191 of all the unit regions may have the same polarity as positive polarity or negative polarity with reference to the voltage of the upper electrode 290

Further, the polarity of the voltage applied to the lower electrode 191 may be inverted based on at least one frame.

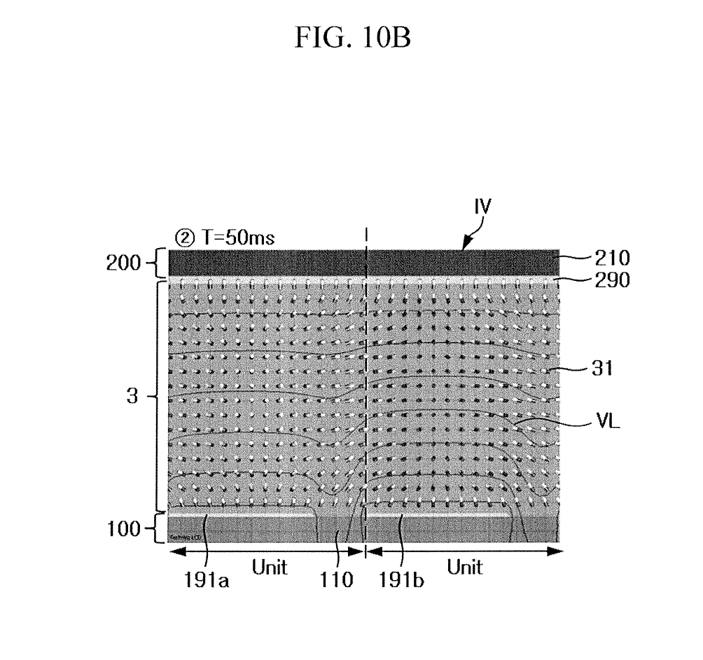

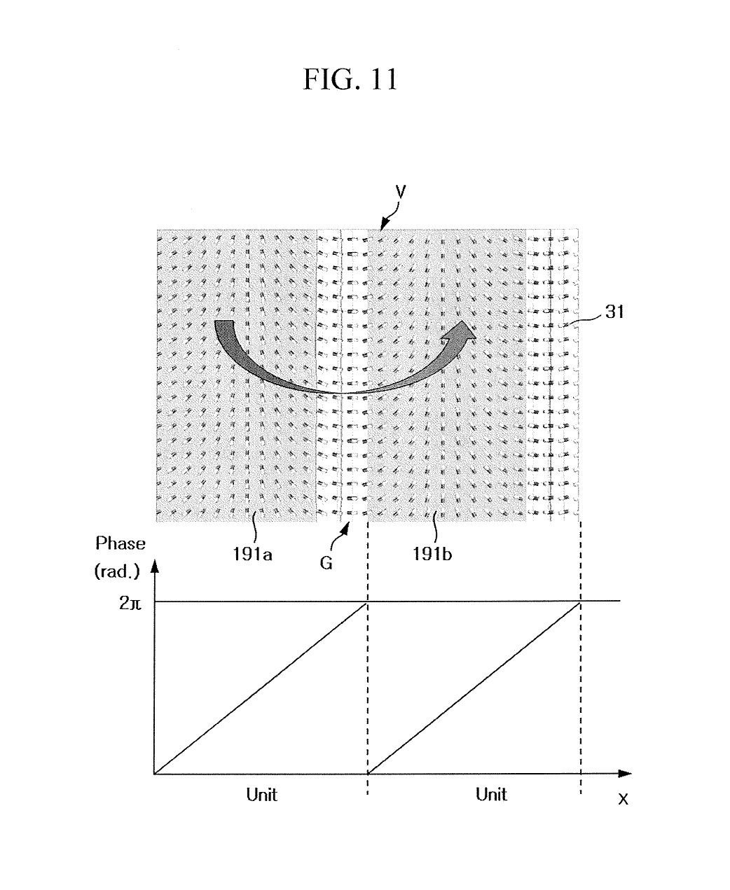

Next, as illustrated in FIG. 10B and FIG. 11, the liquid crystal molecules 31 are re-aligned depending on the electric field generated in the liquid crystal layer 3. For example, the liquid crystal molecules 31 are tilted in approximately parallel with the surface of the first plate 100 or the second plate 200 to form an in-plane alignment. In the in-plane alignment, the major axis rotates on a plane to form an spiral alignment of FIGS. 11 and 12 showing an u-letter alignment. The azimuthal angle of the major axis of the liquid crystal molecules 31 may be changed from approximately 0° to approximately 180° based on a pitch of the lower electrode 191. A portion where the azimuthal angle of the major axis of the liquid crystal molecules 31 is changed from approximately 0° to approximately 180° may form one u-letter alignment.

A predetermined time may be required until the optical modulation device 1 is applied with the driving signal of the step 1 and then the alignment of the liquid crystal molecules 31 is stabilized and the optical modulation device 1 forming the forward phase tilt may be continuously applied with the driving signal of the step 1 unlike one illustrated in FIG. 9.

Referring to FIG. 11, a region in which the liquid crystal molecules 31 may be arranged with rotating by 180° along the x-axis direction may be as one unit region. In the case of the exemplary embodiment, the single unit region may include the space G between the first electrode 191a and the second electrode 191b adjacent thereto.

As described above, when the optical modulation device 1 satisfies the above Equation 1 to implement approximately the half-wavelength plate, the rotating direction of the input circularly polarized light is changed reversely. FIG. 11 illustrates a phase change depending on the position of the x-axis direction, for example, in the case in which the right circularly polarized light is incident on the light modulation device 1. The right circularly polarized light transmitting the optical modulation device 1 is emitted with being changed to the left circularly polarized light and a phase delay value of the liquid crystal layer 3 is changed depending on the x-axis direction and therefore the phase of the emitted circularly polarized light is continuously changed.

If the optical axis of the half-wavelength plate rotates as much as φ on the in-plane, the phase of emitted light is changed as much as 2φ. As illustrated in FIG. 11, the phase of light emitted from one unit region in which the azimuthal angle of the major axis of the liquid crystal molecule 31 is changed 180° is changed from 0 to 2π (radian) along the x-axis direction. This is called the forward phase tilt. The phase change may be repeated every the unit region to implement the forward phase tilt portion of the lens which changes the direction of light using the optical modulation device 1.

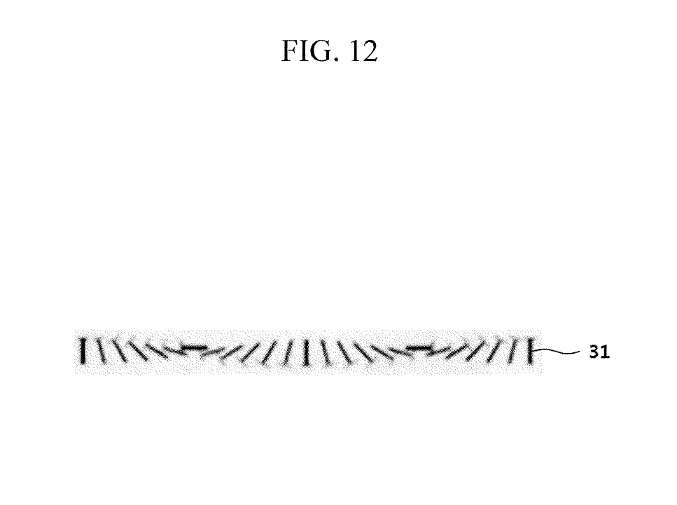

Next, the method for implementing a forward phase tilt using the optical modulation device 1 according to the exemplary embodiment as illustrated in FIG. 11 will be described with reference to FIGS. 13 to 16 along with the drawings described above.

FIG. 13 is a cross-sectional view taken along the line IV of FIG. 8 as a cross-sectional view illustrating the alignment of the liquid crystal molecules 31 before the voltage difference is applied between the first and second electrodes 191a and 191b of the first plate and the upper electrode 290 of the second plate 200 of the optical modulation device 1 according to the exemplary embodiment. Unlike the foregoing drawings, FIGS. 13 to 16 illustrate a portion where one unit region moves in a horizontal direction.

The liquid crystal molecules 31 are initially aligned in a direction approximately vertical to the plane of the first plate 100 and the second plate 200 and may have the pre-tilt along the alignment directions R1 and R2 of the first plate 100 and the second plate 200 as described above. An equi-potential line VL is illustrated in the liquid crystal layer 3.

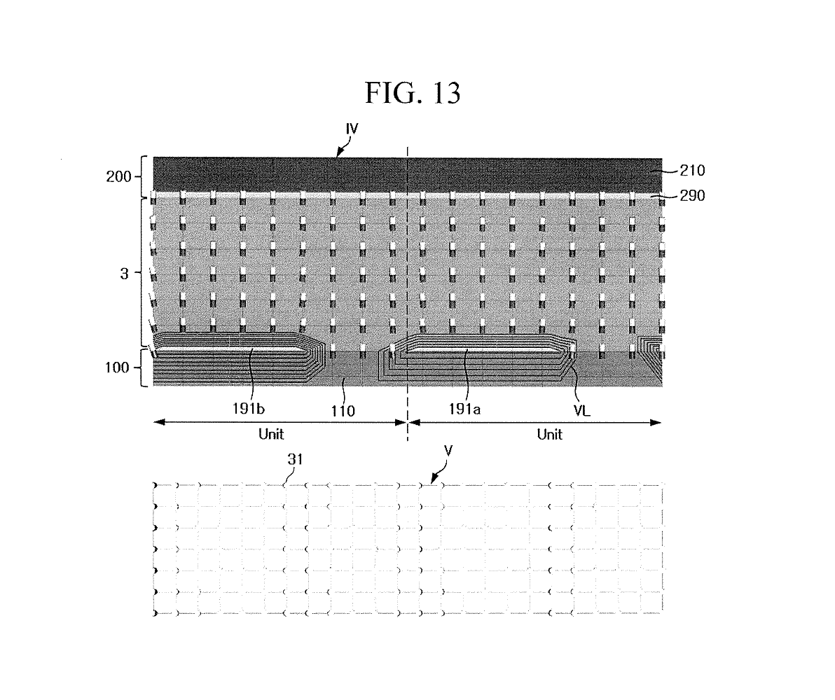

FIG. 14 is a cross-sectional view taken along the line IV of FIG. 8 as a cross-sectional view illustrating the alignment of the liquid crystal molecules 31 when the driving signal of the step 1 is applied between the first and second electrodes 191a and 191b of the first plate and the upper electrode 290 of the second plate 200 of the optical modulation device 1 according to the exemplary embodiment and illustrates a portion where one unit region horizontally moves. An electric field E is generated between the first plate 100 and the second plate 200 and thus the equi-potential line VL is represented. In this case, the first and second electrodes 191a and 191b have edge sides, and therefore as illustrated in FIG. 14, a fringe field is formed between edge sides of the first and second electrodes 191a and 191b and the upper electrode 290.

When the driving signal of the step 1 is applied to the first and second electrodes 191a and 191b and the upper electrode 290, in the liquid crystal layer 3 of the unit region including the second electrode 191b, a strength of electric field in a region D1 adjacent to the first plate 100 is stronger than that of electric field in a region S1 adjacent to the second plate 200 and in the liquid crystal layer 3 of the unit region including the first electrode 191a, a strength of electric field in a region S2 adjacent to the first plate 100 is weaker than that of a strength of electric field in a region D2 adjacent to the second plate 200.

There is a difference between the voltage applied to the first electrode 191a and the voltage applied to the second electrode 191b in the two adjacent unit regions and therefore as illustrated in FIG. 14, the strength of the electric field in the region S2 adjacent to the first electrode 191a may be weaker than that of the electric field in the region D1 adjacent to the second electrode 191b. For this purpose, as illustrated in FIG. 9 described above, the voltage applied to the second electrode 191b may be larger than the voltage applied to the first electrode 191a. The upper electrode 290 may be applied with a voltage different from the voltage applied to the first and second electrodes 191a and 191b, in more detail, a voltage smaller than the voltage applied to the first and second electrodes 191a and 191b.

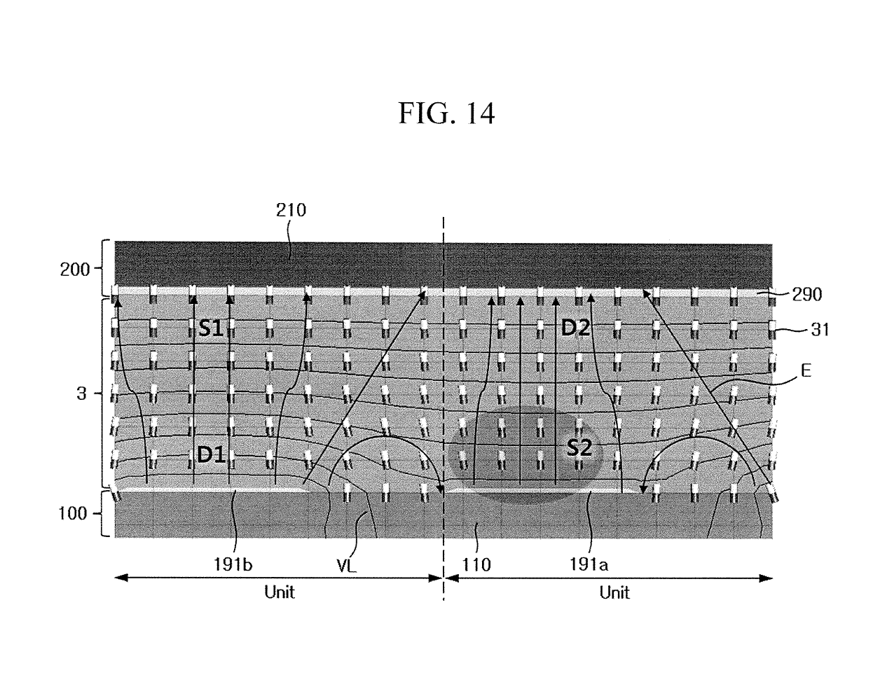

FIG. 15 is a cross-sectional view taken along the line IV of FIG. 8 as a cross-sectional view illustrating the alignment of the liquid crystal molecules 31 reacting to the electric field E generated in the liquid crystal 3 after the driving signal of the step 1 is applied to the optical modulation device 1 illustrated in FIG. 8 and illustrates the portion where one unit region horizontally moves. As described above, in the liquid crystal layer 3 corresponding to the second electrode 191b, the electric field in the region D1 adjacent to the second electrode 191b is the strongest and therefore the tilted direction of the liquid crystal molecules 31 of the region D1 determines the in-plane alignment direction of the liquid crystal molecules 31 corresponding to the second electrode 191b. Therefore, in the region corresponding to the second electrode 191b, the liquid crystal molecules 31 are tilted in the initial pre-tilt direction of the liquid crystal molecules 31 adjacent to the first plate 100 to form the in-plane alignment.

To the contrary, in the liquid crystal layer 3 corresponding to the first electrode 191a, the electric field in the region D2 adjacent to the upper electrode 290 facing the first electrode 191a, not the first electrode 191a, is the strongest and therefore the tilted direction of the liquid crystal molecules 31 in the region D2 determines the in-plane alignment direction of the liquid crystal molecules 31. Therefore, in the region corresponding to the first electrode 191a, the liquid crystal molecules 31 are tilted in the initial pre-tilt direction of the liquid crystal molecules 31 adjacent to the second plate 200 to form the in-plane alignment. The initial pre-tilt direction of the liquid crystal molecules 31 adjacent to the first plate 100 and the initial pre-tilt direction of the liquid crystal molecules 31 adjacent to the second plate 200 are opposite to each other and therefore the tilted direction of the liquid crystal molecules 31 corresponding to the first electrode 191a is opposite to the tilted direction of the liquid crystal molecules 31 corresponding to the second electrode 191b.

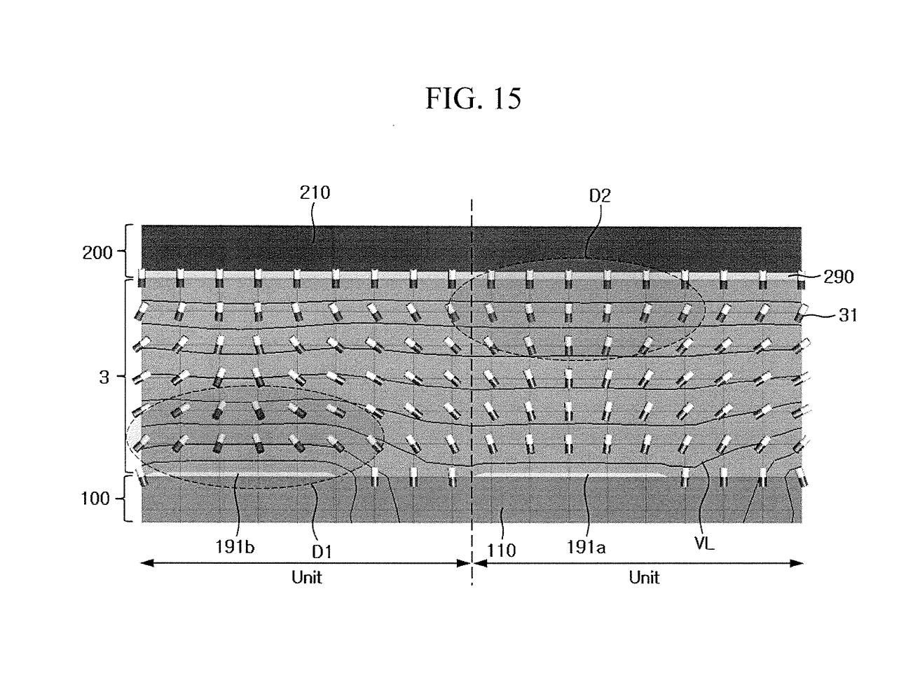

FIG. 16 is a cross-sectional view taken along the line IV of FIG. 8 as a cross-sectional view illustrating the alignment of the stabilized liquid crystal molecules 31 after the driving signal of the step 1 is applied to the optical modulation device 1 illustrated in FIG. 8 and illustrates the portion where one unit region horizontally moves. The in-plane alignment direction of the liquid crystal molecules 31 corresponding to the first electrode 191a is opposite to the in-plane alignment direction of the liquid crystal molecules 31 corresponding to the second electrode 191b and the liquid crystal molecules 31 corresponding to the space G between the first electrode 191a and the second electrode 191b which are adjacent to each other continuously rotate along the x-axis direction to form the spiral alignment.

Finally, the liquid crystal layer 3 of the optical modulation device 1 may give the phase delay changed along the x-axis direction to the incident light.

Referring to FIG. 16, the region in which the liquid crystal molecules 31 are aligned with rotating 180° along the x-axis direction is defined as one unit region, in which one unit region may include the space G between one lower electrodes 191a and 191b and the other lower electrodes 191a and 191b adjacent thereto. For example, when the right circularly polarized light is incident on the optical modulation device 1 forming the forward phase tilt like the exemplary embodiment, the phase change depending on the position in the x-axis direction is represented, the right circularly polarized light is emitted with being changed to the left circularly polarized light, and the phase delay value of the liquid crystal layer 3 is changed depending on the x-axis direction and therefore the phase of the emitted circularly polarized light is continuously changed.

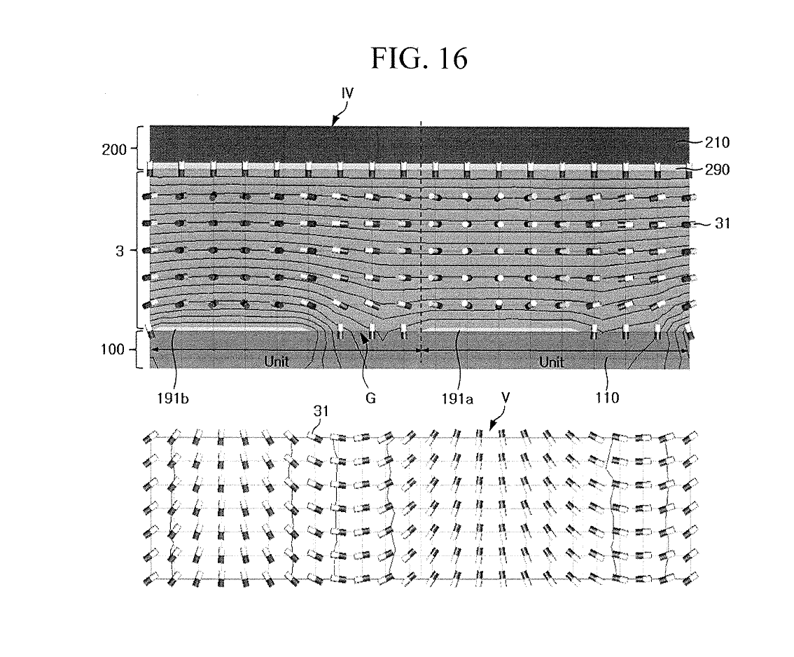

Next, a method for implementing a reverse phase tilt using the optical modulation device 1 according to the exemplary embodiment will be described with reference to FIGS. 17 to 19 along with the drawings described above, in particular, FIGS. 9 to 11.

Referring to the upper left of FIG. 17, when a voltage is not applied to the first and second electrodes 191 and 191b and the upper electrode 290, the liquid crystal molecules 31 are initially aligned in approximately a vertical direction to a plane of the first plate 100 and the second plate 200 and as described above, may have the pre-tilt along the alignment direction of the first plate 100 and the second plate 200.

Referring to FIG. 9 described above, the optical modulation device 1 according to the exemplary embodiment is applied with the driving signal of the step 1 and then the lower electrodes 191a and 191b and the upper electrode 290 may be applied with the driving signal of the step 2 after a predetermined time lapses (for example, 50 ms).

In the step 2, the first electrode 191a and the second electrode 191b which are adjacent to each other may be applied with a voltage having opposite polarity to the voltage applied to the upper electrode 290. For example, the first electrode 191a may be applied with a voltage of −6V based on the voltage of the upper electrode 290 and the second electrode 191b may be applied with a voltage of 6V, and vice versa.

Next, as illustrated in the left lower of FIG. 17, the equi-potential line VL is formed and the liquid crystal molecules 31 of a region A corresponding to the space G between the first and second electrodes 191a and 191b are aligned in an approximately vertical direction to the substrates 100 and 200 and do not have the in-plane spiral alignment.

A section of the step 2 may be, for example, 20 ms, but is not limited thereto.

Unlike the illustrated case, when the unit region includes the plurality of lower electrodes 191, the same voltage may also be applied to all the plurality of lower electrodes 191 of a single unit region and a voltage which is sequentially changed based on at least one lower electrode 191 as a unit may be applied. The voltage applied to the lower electrode 191 of the adjacent unit regions may be applied with a voltage having an opposite polarity to each other based on the voltage of the upper electrode 290

Further, the polarity of the voltage applied to the lower electrode 191 may be inverted every at least one frame.

Next, the optical modulation device 1 according to the exemplary embodiment is applied with a driving signal of step 2 and then the lower electrodes 191a and 191b and the upper electrode 290 is applied with a driving signal of step 3 after a predetermined time (e.g., 20 ms) lapses and may be maintained for the remaining section of the corresponding frame.

A voltage level applied to the lower electrodes 191a and 191b and the upper electrode in the step 3 is similar to the step 1 but a relative size of the voltage applied to the first electrode 191a and the second electrode 191b may be changed inversely. That is, when the voltage applied to the first electrode 191a in the step 1 is smaller than the voltage applied to the second electrode 191b, the voltage applied to the 1^{st} first electrode 191a in the step 3 may be larger than the voltage applied to the second electrode 191b. For example, in the step 3, 10V may be applied to the first electrode 191a, 6V may be applied to the second electrode 191b, and 0V may be applied to the upper electrode 290.

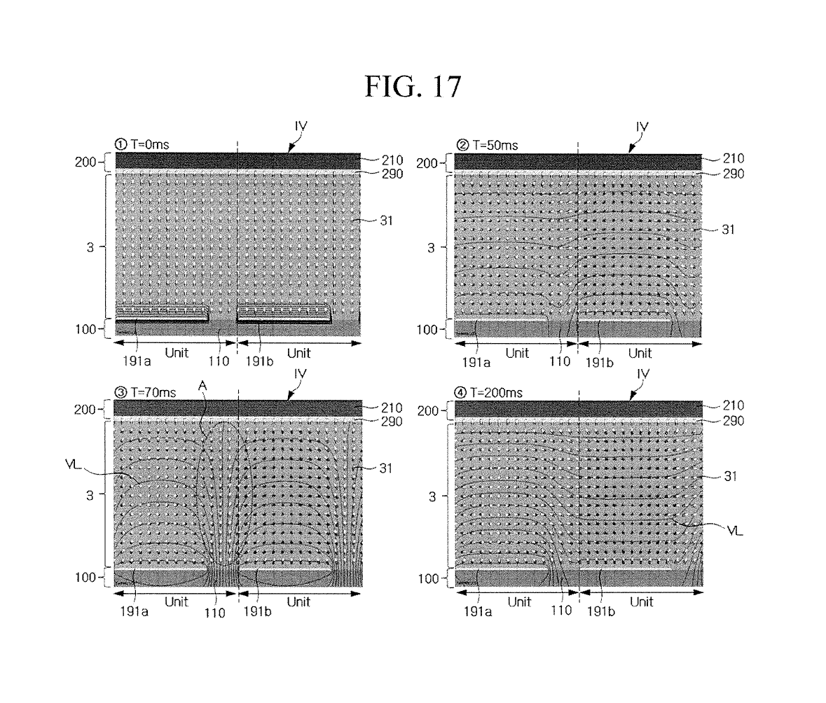

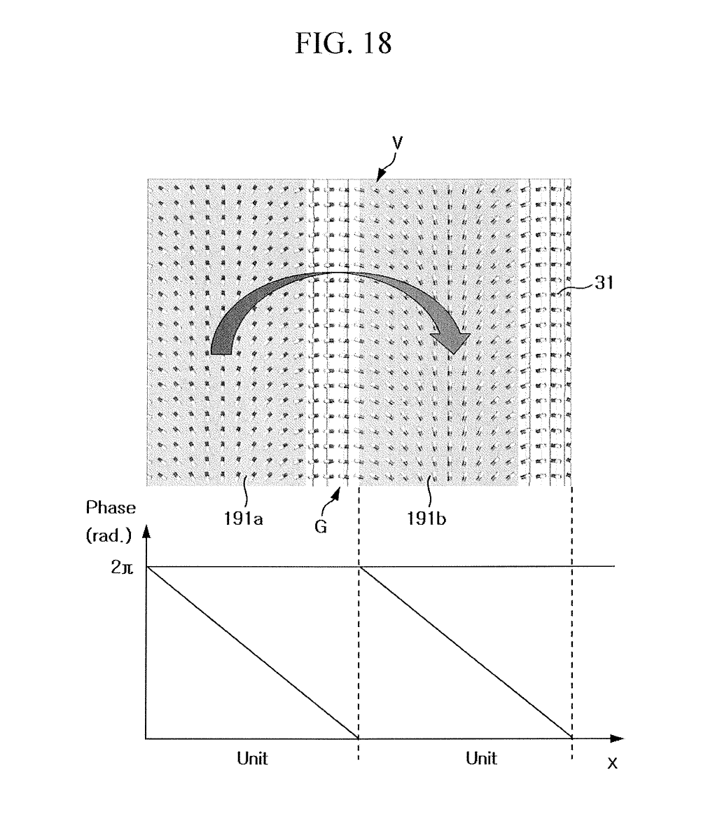

Next, as illustrated in the lower right of FIG. 17 and FIG. 11, the liquid crystal molecules 31 are re-aligned depending on the electric field generated in the liquid crystal layer 3. In detail, most of the liquid crystal molecules 31 are tilted in approximately parallel with the surface of the first plate 100 or the second plate 200 to form the in-plane alignment and the major axis rotates on the in-plane to form the spiral alignment as illustrated in FIGS. 18 and 19, in more detail, an n-letter alignment. The azimuthal angle of the major axis of the liquid crystal molecules 31 may be changed from approximately 180° to approximately 0° based on a pitch of the lower electrode 191. A portion where the azimuthal angle of the major axis of the liquid crystal molecules 31 is changed from approximately 180° to approximately 0° may form one n-letter alignment.

A predetermined time may be required until the optical modulation device 1 is applied with the driving signal of the step 3 and then the alignment of the liquid crystal molecules 31 is stabilized and the optical modulation device 1 forming the reverse phase tilt may be continuously applied with the driving signal of the step 3.

As described above, when the optical modulation device 1 satisfies the above Equation 1 to implement approximately the half-wavelength plate, the rotating direction of the input circularly polarized light is changed reversely. FIG. 18 illustrates a phase change depending on the position in the x-axis direction, for example, in the case in which the right circularly polarized light is incident on the light modulation device 1. The right circularly polarized light transmitting the optical modulation device 1 is emitted with being changed to the left circularly polarized light and a phase delay value of the liquid crystal layer 3 is changed depending on the x-axis direction and therefore the phase of the emitted circularly polarized light is continuously changed.

Generally, when the optical axis of the half-wavelength plate rotates as much as φ on the in-plane, the phase of emitted light is changed as much as 2φ and therefore as illustrated in FIG. 18, the phase of light emitted from one unit region in which the azimuthal angle of the major axis of the liquid crystal molecule 31 is changed from 2π (radian) to 0 along the x-axis direction. This is called a reverse phase tilt. The phase change may be repeated every the unit region to implement the reverse phase tilt portion of the lens which changes the direction of light using the optical modulation device 1.

A method for implementing a reverse phase tilt has the same principle as the method for implementing a forward phase tilt and therefore a detailed description thereof will be omitted.

According to the exemplary embodiment as described above, the in-plane rotating angle of the liquid crystal molecules 31 is easily controlled according to the method for applying a driving signal to variously modulate the optical phase and form various diffraction angles of light.

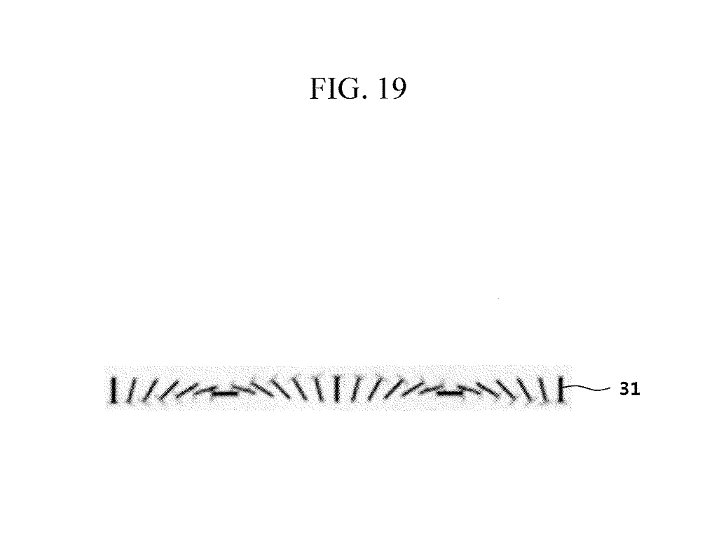

FIG. 20 is a diagram illustrating a phase change depending on a position of a lens which may be implemented using an optical modulation device according to an exemplary embodiment.

The optical modulation device 1 of FIG. 1 may implement both of the forward phase tilt and the reverse phase tilt to form a Fresnel lens. FIG. 20 illustrates the phase change depending on a position of the Fresnel lens implemented by the optical modulation device 1 of FIG. 1. The Fresnel lens is a lens using optical characteristics of a Fresnel zone plate, in which a phase distribution is periodically repeated and thus an effective phase delay may be the same as or similar to a solid convex lens or a green lens.

As illustrated in FIG. 20, based on a center O of a single Fresnel lens, a left portion La includes a plurality of forward phase tilt regions of which the width in the x-axis direction may be different and a right portion Lb includes a plurality of reverse phase tilt regions of which the width in the x-axis direction may be different. Therefore, a portion of the optical modulation device 1 corresponding to the left portion La of the Fresnel lens may apply only the driving signal of the step 1 described above to form the forward phase tilt and a portion of the optical modulation device 1 corresponding to the right portion Lb of the Fresnel lens may sequentially apply the driving signals of the step 1, the step 2, and the step 3 described above to form the reverse phase tilt.

The plurality of forward phase tilts performed by the left portion La of the Fresnel lens may have different widths depending on the position. For this purpose, the width of the lower electrode 191 of the optical modulation device 1 corresponding to each forward phase tilt portion and/or the number of lower electrodes 191 included in one unit region, and the like may be properly controlled. Similarly, the plurality of reverse phase tilts performed by the right portion Lb of the Fresnel lens may have different widths depending on the position. For this purpose, the width of the lower electrode 191 of the optical modulation device 1 corresponding to each reverse phase tilt portion and/or the number of lower electrodes 191 included in one unit region, and the like may be properly controlled.

When the voltage applied to the lower electrode 191 and the upper electrode 290 is controlled, a phase curvature of the Fresnel lens may also be changed.

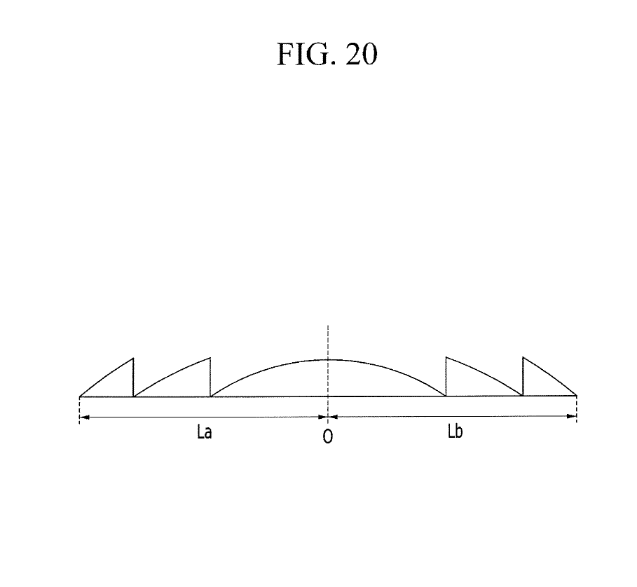

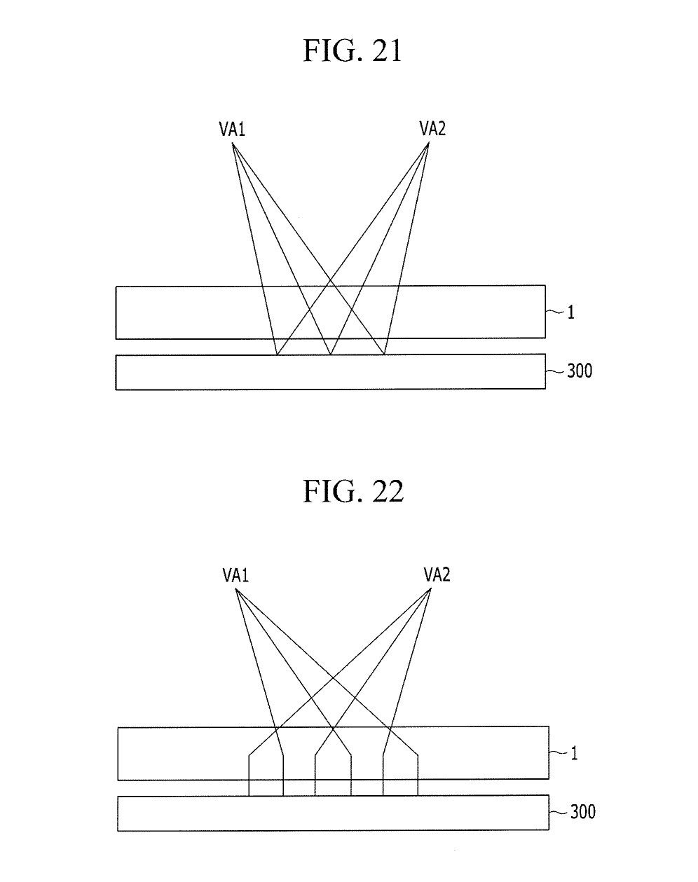

FIGS. 21 and 22 each illustrates a structure of a stereoscopic optical device using an optical modulation device 1 according to an exemplary embodiment and a method for displaying a 2D image and a 3D image.

Referring to FIGS. 21 and 22, an optical device according to an exemplary embodiment is a stereoscopic optical device including a display panel 300 and the optical modulation device 1 positioned in front of a front surface on which an image of the display panel 300 is displayed. The display panel 300 includes a plurality of pixels which display images and may be arranged in a matrix form.

As illustrated in FIG. 21, the display panel 300 may display a 2D image of each frame in a 2D mode and as illustrated in FIG. 22, the display panel 300 may divide images corresponding to multi views such as a right-eye image, a left-eye image, etc., in a 3D mode by a spatial division method and display the divided images. In the 3D mode, some of the plurality of pixels may display an image corresponding to any one view and the others thereof may display images corresponding to other views. The number of views may be equal to or more than two.

The optical modulation device 1 may repeatedly implement the Fresnel lens including the plurality of forward phase tilt portions and the plurality of reverse phase tilt portions to divide the imaged displayed on the display panel 300 at each view.

The optical modulation device 1 may be switched on/off. When the optical modulation device 1 is switched on, the stereoscopic optical device is operated in the 3D mode and as illustrated in FIG. 22 may form the plurality of Fresnel lenses which refract the image displayed on the display panel 300 to display an image at the corresponding view. On the other hand, when the optical modulation device 1 is switched off, as illustrated in FIG. 21, the image displayed on the display plane 300 is transmitted without being refracted and thus the 2D image may be observed.

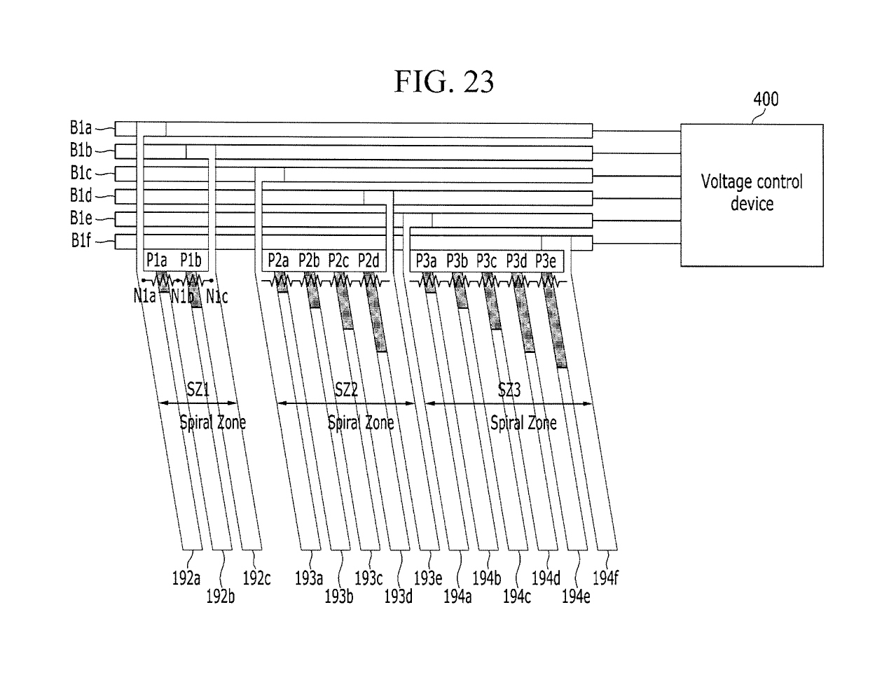

FIG. 23 is a diagram illustrating a resistor string for voltage division in the optical modulation device 1 of FIG. 1 according to an exemplary embodiment.

For an in-plane spiral mode panel, a resistor string may be formed within spiral zones SZ1, SZ2, and SZ3 of the optical modulation device 1. Here, each spiral zone SZ1 to SZ3 may correspond to a region in which the liquid crystal molecules 31 are aligned with rotating along the x-axis direction. For example, each spiral zone SZ1 to SZ3 may correspond to the region in which the spiral alignment (for example, the u-letter alignment of FIGS. 11 and 12 and the n-letter alignment of FIGS. 18 and 19) of the liquid crystal molecules 31 is formed. For convenience of explanation, FIG. 23 illustrates some 192a to 192c, 193a to 193e, and 194a to 194f of the plurality of lower electrodes included in the first plate 100. The lower electrodes 192a to 192c, 193a to 193e, and 194a to 194f of FIG. 23 are the same as/similar to the foregoing lower electrodes 191, 191a, and 191b.

The spiral zone SZ1 includes the plurality of lower electrodes 192a to 192c, the spiral zone SZ2 includes the plurality of lower electrodes 193a to 193e, and the spiral zone SZ3 includes the plurality of lower electrodes 194a to 194f.

Each of the lower electrodes 192a to 192c, 193a to 193e, and 194a to 194f has a bar shape, extending in a diagonal direction with respect to the arranged direction.

The lower electrode 192a of the spiral zone SZ1 is connected to a bus line B1a and the lower electrode 192c of the spiral zone SZ1 is connected to a bus line B1b. A first resistor string is formed between the lower electrodes 192a to 192c of the spiral zone SZ1. The first resistor string includes a plurality of resistors P1a and P1b. Each resistor P1a and P1b may be formed by a deposition of a high resistance material. The resistance of the resistor P1a and P1b may correspond to the length of the resistor P1a and P1b. The high resistance material may be deposited using a sheet of mask. The high resistance material may be directly contacted. For example, each resistor P1a and P1b may be made of nickel-chromium (Ni—Cr), indium zinc oxide (IZO), etc. Each resistor P1a and P1b may be formed between the lower electrodes 192a to 192c. A connection of the resistors P1a and P1b formed between the lower electrodes 192a to 192c is a series-shunt connection of the resistors P1a and P1b.

The spiral zones SZ2 and SZ3 may be formed by the same method as the spiral zone SZ1. For example, the lower electrode 193a of the spiral zone SZ1 is connected to a bus line B1c and the lower electrode 193e of the spiral zone SZ2 is connected to a bus line B1d. A second resistor string is formed between the lower electrodes 193a to 193e of the spiral zone SZ2. The second resistor string includes a plurality of resistors P2a to P2d. Each resistor P2a to P2d may be formed by a deposition of a high resistance material. The resistance of the resistor P2a to P2d may correspond to a deposition length of the resistor P2a to P2d. Each resistor P2a to P2d may be formed between two adjacent electrodes of the lower electrodes 193a to 193e.

The lower electrode 194a of the spiral zone SZ3 is connected to a bus line B1e and the lower electrode 194f of the spiral zone SZ3 is connected to a bus line B1f. A third resistor string is formed between the lower electrodes 194a to 194f of the spiral zone SZ3. The third resistor string includes a plurality of resistors P3a to P3e. Each resistor P3a to P3e may be formed by a deposition of a high resistance material. The resistance of each resistor P3a to P3e may correspond to a deposition length of the resistor P3a to P3e. Each resistor P3a to P3e may be formed between two adjacent lower electrodes of the lower electrodes 194a to 194f. For convenience of explanation, FIG. 23 illustrates the case in which the resistors P3a to P3e are formed between all the lower electrodes 194a to 194f, but the resistors need not be formed between some of the lower electrodes. For example, the resistor P3e need not be formed between the lower electrode 194e and the lower electrode 194f.

A voltage control device 400 applies a voltage to the optical modulation device 1 through the bus lines B1a to B1f. For example, the voltage control device 400 may include a driver integrated circuit (D-IC) and/or an external amplifier which directly applies a voltage to the optical modulation device 1 through a flexible printed circuit separated from the D-IC. The voltage control device 400 may be included in an optical device.

When the bus line B1a and the bus line B1b are applied with a voltage from the voltage control device 400, the voltage is divided by the first resistor string and the divided voltage is applied to the lower electrodes 192a to 192c of the spiral zone SZ1. For example, the voltage applied to the bus line B1a is V1a and the voltage applied to the bus line B1b is V1b. Here, it is assumed that V1b is greater than V1a. A voltage (e.g. voltage applied to the lower electrode 192c) of a node N1c is V1b. A voltage (e.g. voltage applied to the lower electrode 192b) of a node N1b is (V1b-voltage dropped by the resistor P1b). A voltage (e.g. voltage applied to the lower electrode 192a) of a node N1a is V1a (e.g. V1b-voltage dropped by the resistor P1b-voltage dropped by the resistor P1a). When the V1b is larger than the V1a, a monotonically increasing voltage is applied to the lower electrodes 192a to 192c. For example, the voltage applied to the lower electrode 192b is larger than the voltage applied to the lower electrode 192a and the voltage applied to the lower electrode 192c is larger than the voltage applied to the lower electrode 192b. To the contrary, when the V1a is larger than the V1b, a monotonically decreasing voltage is applied to the lower electrodes 192a to 192c.

When a voltage is applied to the bus lines B1c and Bid for the spiral zone SZ2, similarly to the spiral zone SZ1, the voltage is divided through the second resistor string and the divided voltage is applied to the lower electrodes 193a to 193e of the spiral zone SZ2. The lower electrodes 193a to 193e may be applied with the monotonically increasing or decreasing voltage.

When a voltage is applied to the bus lines B1e and B1f for the spiral zone SZ3, similarly to the spiral zone SZ1, the voltage is divided through the third resistor string and the divided voltage is applied to the lower electrodes 194a to 194f of the spiral zone SZ3. The lower electrodes 194a to 194f may be applied with the monotonically increasing or decreasing voltage.

According to the exemplary embodiment, as illustrated in FIG. 23, the electrode structure may be simplified by using the resistor string for voltage division and the number of bus lines for each spiral zone SZ1 to SZ3 may be minimized. For example, though the spiral zone SZ3 includes six lower electrodes 194a to 194f, but to apply a voltage to the six lower electrodes 194a to 194f, only the two bus lines B1e and B1f connected to the lower electrodes 194a and 194f of both ends of the spiral zone SZ3 are needed.

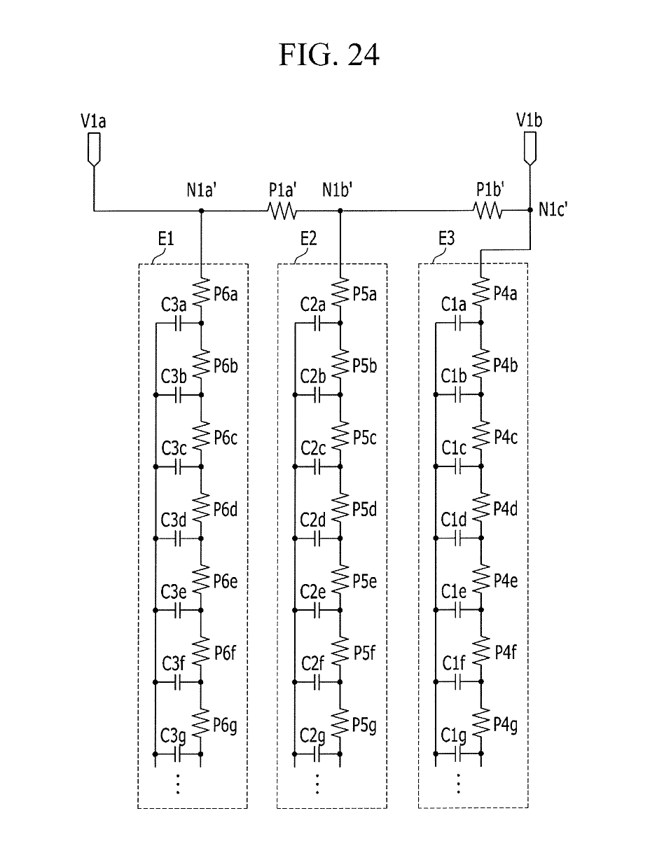

FIG. 24 is a diagram illustrating a RC modeling to the spiral zone SZ1 of FIG. 23.

A resistor P1a′ of FIG. 24 corresponds to the resistor P1a of FIG. 23 and a resistor P1b′ of FIG. 24 corresponds to the resistor P1b of FIG. 23. A node N1a′ of FIG. 24 corresponds to the node N1a of FIG. 23, a node N1b′ of FIG. 24 corresponds to the node N1b of FIG. 23, and a node N1b′ of FIG. 24 corresponds to the node N1b of FIG. 23. An electrode E1 connected to the node N1a corresponds to the lower electrode 192a of FIG. 23, an electrode E2 connected to the node N1b′ corresponds to the lower electrode 192b of FIG. 23, and an electrode E3 connected to the node N1c′ corresponds to the lower electrode 192c of FIG. 23.

The RC equivalent to the lower electrode 192a may include a plurality of resistors P6a to P6g and a plurality of capacitors C3a to C3g. The RC equivalent to the lower electrode 192b may include a plurality of resistors P5a to P5g and a plurality of capacitors C2a to C2g. The RC equivalent to the lower electrode 192c may include a plurality of resistors P4a to P4g and a plurality of capacitors C1a to C1g.

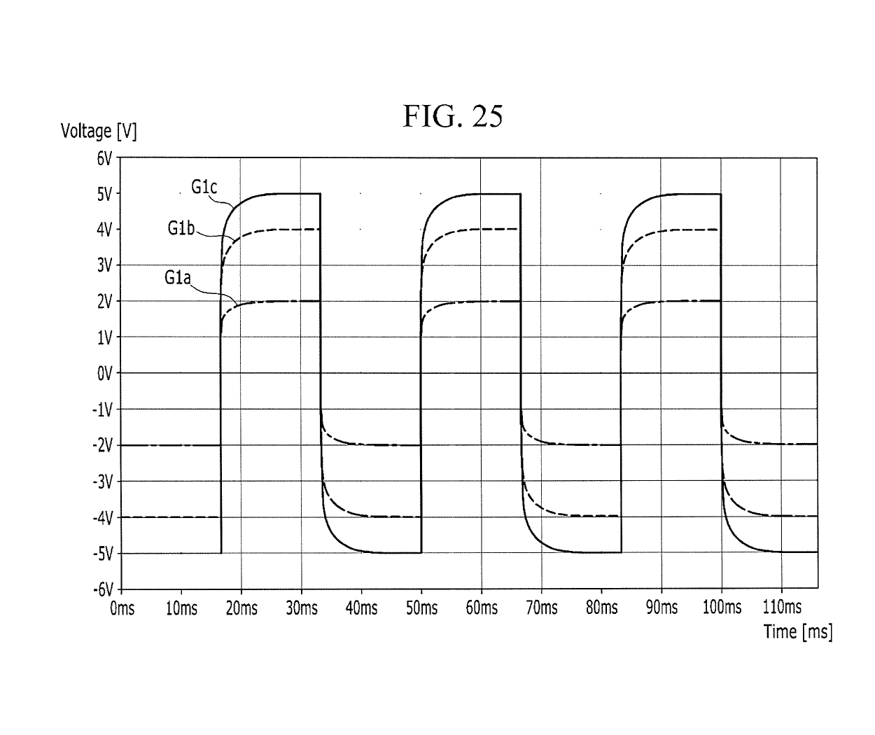

FIG. 25 is a simulation program with integrated circuit emphasis (SPICE) simulation result illustrating a voltage applied to the electrodes E1 to E3 of FIG. 24. In FIG. 25, it is assumed that the V1b is larger than Via.

A graph G1a represents a voltage applied to the electrode E1, a graph G1b represents a voltage applied to the electrode E2, and a graph G1c represents a voltage applied to the electrode E3. The V1b and the Via are divided by the resistors P1a′ and P1b′ coupled in series and the divided voltage is applied to each electrode E1 to E3. In detail, the monotonically increasing voltage is applied to the electrodes E1 to E3. That is, the voltage applied to the electrode E2 is larger than the voltage applied to the electrode E1 and the voltage applied to the electrode E3 is larger than the voltage applied to the electrode E2.

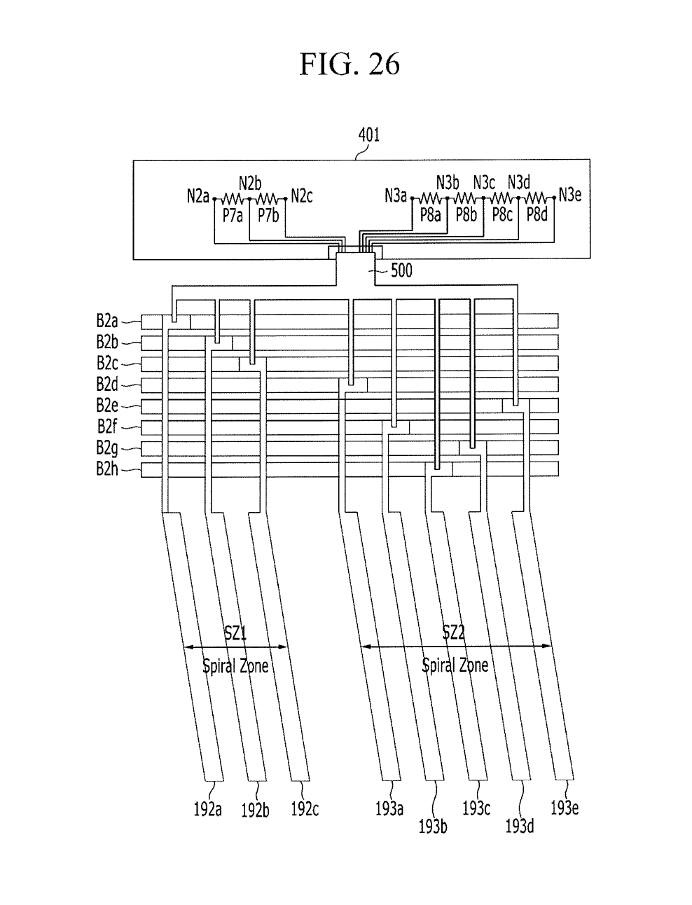

FIG. 26 is a diagram illustrating a resistor string formed in a voltage control device 401 controlling a voltage applied to the optical modulation device 1 of FIG. 1 according to an exemplary embodiment. The resistor string of FIG. 23 is formed within the spiral zones SZ1 to SZ3 but is different from the resistor string of FIG. 26 in that it is formed within the voltage control device 401. For convenience of explanation, FIG. 26 illustrates the two spiral zones SZ1 and SZ2 of the plurality of spiral zones included in the optical modulation device 1. The voltage control device 401 may be included in an optical device.

For example, each lower electrode 192a to 192c of the spiral zone SZ1 is connected to different bus lines B2a to B2c and each lower electrode 193a to 193e of the spiral zone SZ2 is connected to different bus lines B2d to B2h.

The voltage control device 401 directly applies a voltage to the bus lines B2a to B2h connected to the optical modulation device 1 through a connector 500. The voltage control device 401 may be included in a control board. For example, the voltage control device 401 may include a resistor string (for example, fourth resistor string and fifth resistor string) formed by using a lumped resistor. The fourth resistor string may include a plurality of resistors P7a and P7b coupled in series and the fifth resistor string may include a plurality of resistors P8a to P8d coupled in series. The voltage control device 401 divides a voltage through the resistor string (fourth resistor string and fifth resistor string) and applies the divided voltage to the bus lines B2a to B2h through the connector 500. The voltage of the node N2a may be applied to the lower electrode 192a through the bus line B2a, the voltage of the node N2b may be applied to the lower electrode 192b through the bus line B2b, and the voltage of the node N2c may be applied to the lower electrode 192c through the bus line B2c. The voltage of the nodes N2a to N2c may be the monotonically increasing or decreasing voltage. The voltage of the node N3a may be applied to the lower electrode 193a through the bus line B2d, the voltage of the node N3b may be applied to the lower electrode 193b through the bus line B2f, the voltage of the node N3c may be applied to the lower electrode 193c through the bus line B2h, the voltage of node N3d may be applied to the lower electrode 193d through the bus line B2g, and the voltage of the node N3e may be applied to the lower electrode 193e through the bus line B2e. The voltage of the nodes N3a to N3e may be the monotonically increasing or decreasing voltage.

For example, the voltage V2a is applied to the node N2a and the voltage V2b is applied to the node N2c. Herein, it is assumed that V2b is greater than V2a. The voltage (e.g. V2b) of the node N2c is applied to the lower electrode 192c through the bus line B2c. The voltage (e.g. V2b-voltage dropped by the resistor P7b) of the node N2b is applied to the lower electrode 192b through the bus line B2b. The voltage (e.g. V2a=V2b-voltage dropped by the resistor P7b-voltage dropped by the resistor P7a) of the node N2a is applied to the lower electrode 192a through the bus line B2a. Accordingly, the monotonically increasing voltage is applied to the lower electrodes 192a to 192c.

In an exemplary embodiment, the voltage V3a is applied to the node N3a and the voltage V3b is applied to the node N3e. Herein, it is assumed that V3a is greater than V3b. The voltage (e.g. V3a) of the node N3a is applied to the lower electrode 193a through the bus line B2d. The voltage (e.g. V3a-voltage dropped by the resistor P8a) of the node N3b is applied to the lower electrode 193b through the bus line B2f. The voltage (e.g. V3a-voltage dropped by the resistors P8a and P8b) of the node N3c is applied to the lower electrode 193c through the bus line B2h. The voltage (e.g. V3a—voltage dropped by the resistors P8a, P8b, and P8c) of the node N3d is applied to the lower electrode 193d through the bus line B2g. The voltage (e.g. V3b=V3a-voltage dropped by the resistors P8a, P8b, P8c, and P8d) of the node N3e is applied to the lower electrode 193e through the bus line B2e. Accordingly, the monotonically decreasing voltage is applied to the lower electrodes 193a to 193e.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An optical modulation device, comprising:
a plurality of bus lines extended in a first direction, wherein each bus line supplies a respective voltage;
a first plate including a plurality of first lower electrodes extended in a second direction crossing the first direction, wherein a rightmost first lower electrode is connected to a first bus line of the bus lines and a leftmost first lower electrode is connected to a second bus line of the bus lines;
a second plate facing the first plate and including at least one upper electrode;
a liquid crystal layer positioned between the first plate and the second plate and including a plurality of liquid crystal molecules; and
a first resistor string including a plurality of first resistors, wherein each resistor positioned between two adjacent first lower electrodes connects electrically the two adjacent first lower electrodes, causing a voltage difference between the two adjacent first electrodes.

2. The optical modulation device of claim 1, wherein
the resistance material includes at least one of nickel-chromium (Ni—Cr) and indium zinc oxide (IZO).

3. The optical modulation device of claim 1, wherein
the first resistors are coupled in series to each other.

4. The optical modulation device of claim 3, wherein a number of the first lower electrodes is greater than two, wherein the number of two is a number of bus lines physically connected to the first lower electrodes.

5. The optical modulation device of claim 4, further comprising:
a plurality of second lower electrodes extended in a third direction substantially parallel to the second direction, wherein a rightmost second lower electrode is connected to a third bus line and a leftmost second lower electrode is connected to a fourth bus line.

6. The optical modulation device of claim 5, wherein a number of the second lower electrodes is greater than two, and the number of the second lower electrodes is greater than the number of the first lower electrodes.

7. The optical modulation device of claim 5, further comprising:
a second resistor string including a plurality of resistors, wherein each second resistor positioned between two adjacent second lower electrodes connects electrically the two adjacent second lower electrodes, causing a voltage difference between the two adjacent second electrodes.

8. An optical device, comprising:
an optical modulation device including a plurality of spiral zones, wherein each spiral zone includes a plurality of lower electrodes;
a plurality of bus lines connected to the lower electrodes in a predetermined manner; and
a voltage control device configured to generate a plurality of voltages applied to the optical modulation device through the bus lines, wherein a number of lower electrodes of each zone is different from a number of lower electrodes of a neighboring spiral zone.

9. The optical device of claim 8, wherein each spiral zone is connected to two bus lines in the predetermined manner where a rightmost lower electrode of each spiral zone is connected to one bus line of the two bus lines, a leftmost lower electrode of each spiral zone is connected to the other bus line of the two bus lines and other lower electrodes are coupled to each other through a respective resistor.

10. The optical device of claim 8, wherein the voltage control device includes a first resistor string configured to divide a voltage through a plurality of first resistors coupled in series and apply the divided voltage to a plurality of bus lines connected to the optical modulation device.

11. The optical device of claim 10, wherein:
a voltage of each spiral zone monotonically increases or decreases.

12. A driving method of an optical modulation device, comprising:
receiving a first voltage through a first bus line connected to a leftmost first lower electrode of a plurality of first lower electrodes;
receiving a second voltage through a second bus line connected to a rightmost first lower electrode of the plurality of first lower electrodes;
dividing a voltage difference between the first voltage and the second voltage through a plurality of first resistors positioned between the plurality of first lower electrodes; and
applying the divided voltage to the plurality of first lower electrodes.

13. The driving method of claim 12, wherein the optical modulation device includes:
a first plate including the plurality of first lower electrodes;
a second plate facing the first plate and including at least one upper electrode; and
a liquid crystal layer positioned between the first plate and the second plate and including a plurality of liquid crystal molecules.

14. The driving method of claim 13, wherein the plurality of first resistors coupled in series are each formed by a deposition of a high resistance material.

15. The driving method of claim 14, wherein the high resistance material includes nickel-chromium (Ni—Cr).

16. The driving method of claim 13, wherein the applying of the divided voltage includes:
applying the first voltage to a rightmost first lower electrode of the plurality of first lower electrodes; and
applying the first voltage, which is equal to or larger than the first voltage, to a rightmost first lower electrode of the plurality of first lower electrodes.

17. The driving method of claim 13, wherein the applying of the divided voltage includes:
applying the first voltage to a leftmost first lower electrode of the plurality of first lower electrodes; and
applying the first voltage, which is equal to or smaller than the first voltage, to a rightmost first lower electrode of the plurality of first lower electrodes.
